(19) United States
(12) Patent Application Publication
(10) Pub. No.: US 2024/0421332 A1
(43) Pub. Date: Dec. 19, 2024

(54) APPARATUS FOR MANUFACTURING SHAPE-CHANGED MEMBRANE-ELECTRODE ASSEMBLY

(71) Applicants: HYUNDAI MOTOR COMPANY, SEOUL (KR); KIA CORPORATION, SEOUL (KR)

(72) Inventor: Woo Jin Lee, Seoul (KR)

(21) Appl. No.: 18/427,211

(22) Filed: Jan. 30, 2024

(30) Foreign Application Priority Data
Jun. 19, 2023 (KR) 10-2023-0078182

(51) Int. Cl. H01M 8/1004; H01M 4/86; H01M 4/88; H01M 8/0297

(52) U.S. Cl. CPC H01M 8/1004; H01M 4/8636; H01M 4/8896; H01M 8/0297

(57) ABSTRACT

A system for manufacturing a shape-changed membrane-electrode assembly includes a first transportation unit configured to transport a first electrode film, a second transportation unit configured to transport a second electrode film, and a third transportation unit configured to transport an electrolyte membrane. Through a roll press, which includes a primary-reaction-section pattern and an auxiliary-reaction-section pattern, transfer pressure, the shape-changed membrane-electrode assembly can be kept uniform during a transfer pressure process, one of processes of manufacturing the membrane-electrode assembly.

### CROSS REFERENCE TO RELATED APPLICATIONS

This application claims under 35 U.S.C. § 119 (a) the benefit of priority to Korean Patent Application No. 10-2023-0078182 filed on Jun. 19, 2023, the entire contents of which are incorporated herein by reference.

### BACKGROUND

### (a) Technical Field

The present disclosure relates to a shape-changed membrane-electrode assembly.

### (b) Background Art

In a fuel cell vehicle, a membrane-electrode assembly (EMA) for a fuel cell serves to generate electric energy. In the membrane-electrode assembly, a cathode is positioned on top of the electrolyte membrane, and an anode is positioned underneath the electrolyte membrane. When air (oxygen) is supplied to the cathode and hydrogen is supplied to the anode, a voltage of approximately 1 V is generated. A gas diffusion layer (GDL), which forms a flow path for electricity transfer and material transfer, and a separation plate are sequentially stacked on the membrane-electrode assembly (which results in forming a cell). Several hundreds of cell sheets are in serial connected to generate energy necessary for driving a vehicle.

A voltage generated in membrane-electrode assembly tends to depend on the required output. The larger the required amount of electric current, the higher electric resistance and material transfer resistance become. Accordingly, a graph resulting from electric current and voltage shows an IV curve that tends to be inversely proportional. At this point, cell efficiency is proportional to cell voltage (voltage/OCV), while a loss is proportional to a decrease in voltage (1-voltage/OCV).

In order for a hydrogen fuel cell to be mounted in the vehicle, the membrane-electrode assembly for the fuel cell has to be limited in size. That is, various BOP components and a stack have to be mounted together within an engine room space in the vehicle, and the membrane-electrode assembly for the fuel cell is positioned in a space unoccupied by a manifold, various accessory components, a casing, and the like within the stack. Because of this, there is a need to maximally secure a reaction section while satisfying a layout requirement for arrangement in a limited space. That is, when the layout requirement for arrangement in the limited space is satisfied, it is possible to mount the membrane-electrode assembly. However, in order to enhance operating efficiency, it is necessary to lower electric current density by maximizing the reaction section.

A decal method is used as one of principal techniques of producing the membrane-electrode assembly in large quantities. The decal method refers to a process of coating a release paper sheet with an electrode using a coating apparatus and transferring the electrode onto an electrolyte membrane through thermal pressing. In the coating process, the electrode is formed in the shape of a rectangle on the release paper sheet, and when thermally pressed, the electrode is subject to pressure while heated. The pressure is in proportion to a load (=a load by pressing itself+an additional load applied by an apparatus) and a distance over which the pressing is applied. That is, although a load with the same magnitude is applied, when a length of the electrode changes, an area to which the load is applied changes, and thus a force that is applied to electrolyte particles changes.

Usually, in a case where thermal transfer is performed using a flat press or a roll press, pressure is difficult to apply to an entire area of the electrode. Because of this, product uniformity is difficult to secure, which leads to a decrease in quality and performance of the fuel cell. For example, the lower pressure to be applied to the electrode, the more disadvantageous the processing capability becomes (a decrease in transfer yield). The higher pressure to be applied to the electrode, the smaller a gap between the electrolyte particles becomes, thereby causing a disadvantage in water discharge (a decrease in the durability of the MEA). Because of this, transfer pressure is a critical factor that needs to be consistently managed during the transfer process.

### SUMMARY

An object of the present disclosure is to provide a system for manufacturing a membrane-electrode assembly having a shape-changed electrode in order to improve the durability and performance of the membrane-electrode assembly.

Another object of the present disclosure is to provide a method of manufacturing a membrane-electrode assembly, the method being performed using the system for manufacturing a membrane-electrode assembly.

The present disclosure is not limited to the above-mentioned objects. The objects of the present disclosure will be more clearly understandable from the following detailed description and can be realized by external and internal limitations and a combination thereof that are recited in the claims.

According to an aspect of the present disclosure, there is provided a system for manufacturing a membrane-electrode assembly, the system including a first transportation unit configured to transport a first electrode film, a second transportation unit configured to transport a second electrode film, a third transportation unit configured to transport an electrolyte membrane having a predetermined width in such a manner that the electrolyte membrane is interposed between the first electrode film and the second electrode film, and one pair of roll presses configured to press, downward from above and upward from below, respectively, against the first electrode film, the electrolyte membrane, and the second electrode film that are pulled in therebetween from one lateral direction.

In the system, one of the one pair of the roll presses includes a primary-reaction-section pattern formed in such a manner as to protrude from a surface thereof, and auxiliary-reaction-section patterns formed in such a manner as to protrude from both sides, respectively, of the primary-reaction-section pattern in a widthwise direction of the electrolyte membrane.

In the system, the primary-reaction-section pattern may have at least one of a polygonal shape and a curve shape, and the primary-reaction-section patterns.

In the system, the primary-reaction-section pattern may have at least one polygonal shape, the primary-reaction-section patterns may be arranged to be spaced apart from each other, and the primary-reaction-section pattern may include an embossed body, and protrusions protruding from both ends, respectively, of the embossed body along a lengthwise direction of a rotational shaft of the roll press.

In the system, the primary-reaction-section pattern may have a polygonal shape having n (n is an even number that is equal to or greater than 6) sides and angles.

In the system, the auxiliary-reaction-section pattern may have at least one of a polygonal shape and a curve shape and may correspond in shape to the primary-reaction-section pattern.

In the system, at an arbitrary point on the primary-reaction-section pattern, a total sum of a length of the primary-reaction-section pattern in a lengthwise direction of a rotational shaft of the roll press and a length of the auxiliary-reaction-section pattern in the lengthwise direction of the rotational shaft of the roll press on the same line as the arbitrary point may be kept constant.

In the system, the auxiliary-reaction-section pattern may have a greater thickness than the primary-reaction-section pattern.

In the system, the auxiliary-reaction-section pattern may have a thickness smaller than the sum of respective thicknesses of the primary-reaction-section pattern and a thickness of the first electrode film, the electrolyte membrane, and the second electrode film that are pulled in between the roll presses from one lateral direction.

In the system, the auxiliary-reaction-section pattern may have a thickness that is the same as the sum of a thickness of the primary-reaction-section pattern and respective thicknesses of the first electrode film, the electrolyte membrane, and the second electrode film that are pushed out in the other lateral direction.

The system may further include an elastic body arranged at least one of a position between the roll press and the first electrode film and a position between the roll press and the second electrode film.

In the system, the elastic body may be formed of at least one selected from the group consisting of polyethyleneterephthalate (PET), polycarbonate (PC), polymethyl methacrylate (PMMA), polyethylene naphthalate (PEN), polyimide (PI), and polyethersulfone (PES).

In the system, the elastic body may structurally include a film with a thickness of 200 μm to 500 μm.

In the system, the primary-reaction-section patterns may have a plurality of hexagonal shapes, respectively, the plurality of hexagonal shapes of the primary-reaction-section patterns may be alternatively arranged to be spaced a predetermined distance apart from each other, and the auxiliary-reaction-section patterns may have a plurality of triangular shapes, respectively, that correspond to the shapes of the primary-reaction-section patterns.

In the system, the primary-reaction-section patterns may have a plurality of octagonal shapes, respectively, the primary-reaction-section patterns may be arranged to be spaced a predetermined distance apart from each other, the auxiliary-reaction-section patterns may have a plurality of triangular shapes, respectively, that correspond to the shapes of the primary-reaction-section patterns, and the auxiliary-reaction-section patterns having the plurality of triangular shapes, respectively, may be arranged to be spaced apart from each other.

In the system, the roll press may include n (n is a natural number that is equal to or greater than 2) columns of the primary-reaction-section patterns, the primary-reaction-section patterns may have a plurality of hexagonal shapes, respectively, the primary-reaction-section patterns may be arranged to be spaced a predetermined distance apart from each other, and the auxiliary-reaction-section pattern may correspond in shape to the primary-reaction-section pattern, but the sum of a width of the auxiliary-reaction-section pattern in a widthwise direction of the electrolyte membrane at an arbitrary point on the primary-reaction-section pattern and a width of the auxiliary-reaction-section pattern may be kept constant.

In the system, the roll press may include three or more columns of the primary-reaction-section patterns.

The use of the system for manufacturing membrane-electrode assembly according to the present disclosure, which includes the roll press having the primary-reaction-section pattern and the auxiliary-reaction-section pattern makes it possible to uniformly maintain transfer pressure during a process of transferring an electrolyte membrane. As a result, the problem of decreased durability, caused by a reduction in a gap between electrolyte particles when high transfer pressure is applied, and the resulting disadvantage in water discharge, can be prevented. Furthermore, the problem of decreased yield, caused by incomplete transfer of the electrolyte membrane when low transfer pressure is applied, can be prevented.

In the related art, an electrode is applied in the shape of a rectangle to the electrolyte membrane. In contrast, the electrode according to the present disclosure is formed by protrusive extension over a predetermined distance from the central areas of both end portions in the longitudinal direction of the rectangular electrode in the related art. As a result, the electrode can be applied up to the unused area of the electrolyte membrane, thereby preventing the unused space from remaining idle. Moreover, both edge portions in the longitudinal direction of the electrode are size-reduced by a predetermined depth. This can provide the advantage of preventing low durability, caused by ineffective or excessive supply of gas to the edge portions.

The present disclosure is not limited to the above-mentioned advantageous effects. The present disclosure should be understood as providing other advantageous effects deductible from the following detailed description.

### BRIEF DESCRIPTION OF THE FIGURES

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 is a perspective view illustrating a system for manufacturing a membrane-electrode assembly according to an embodiment of the present disclosure;

FIG. 2 is a view illustrating one surface of a first electrode film that is included in the system according to the present disclosure;

FIG. 3 is a view illustrating one surface of a second electrode film that is included in the system according to the present disclosure;

FIG. 4 is a cross-sectional view illustrating a membrane-electrode assembly (MEA) that is manufactured using the system according to the embodiment of the present disclosure;

FIG. 5 is a view illustrating a surface of a roll press in a first implementation example according to the embodiment of the present disclosure;

FIG. 6 is a view illustrating the surface of the roll press in the first implementation according to the embodiment of the present disclosure;

FIG. 7 is a cross-sectional view taken along line A-A′ on the surface of the roll press in the first implementation example according to the embodiment of the present disclosure in FIG. 6;

FIG. 8 is a view illustrating a surface of a roll press in a second implementation example according to the embodiment of the present disclosure;

FIG. 9 is a view illustrating a surface of a roll press in a third implementation according to the embodiment of the present disclosure; and

FIG. 10 is a view illustrating a surface of a roll press in a fourth implementation example according to the embodiment of the present disclosure.

### DETAILED DESCRIPTION

The above-mentioned objects, other objects, features, and advantages of the present disclosure would be easily understood from preferred embodiments of the present disclosure that will be described below with reference to the accompanying drawings. However, the present disclosure is not limited to the embodiments described below and may be practiced in other forms. Description of the embodiments in sufficient detail will be provided to contain adequate enabling disclosure and to enable a person of ordinary skill in the art to get a full understanding of the technical idea of the present disclosure.

In the drawings that are referred to for description, the same constituent elements are given the same reference numeral. Constituent elements in the accompanying drawings appear larger than they are actually because they are magnified by increasing dimensions thereof to clearly describe the embodiments of the present disclosure. The terms first, second, and so on may be used to describe various constituent elements, but should not impose any limitation on the meanings of the constituent elements. These terms are used only to distinguish one constituent element from another. For example, a first constituent element may be named a second constituent element without departing from the scope of the present disclosure. In the same manner, the second constituent element may also be named the first constituent element. A noun in singular form has the same meaning as when used in plural form, unless it has a different meaning in context.

It should be understood that the terms “include,” “have,” and the like, when used in the present specification, each specify the presence of a feature, a number, a step, an operation, a constituent element, a component, and/or a combination thereof but do not preclude the possible presence or addition of one or more other features, numbers, steps, operations, constituent elements, components, and/or combinations thereof. In addition, a component, such as a layer, a film, a region, or a plate, when expressed as being on “top” of another component, is meant to be vertically on another component, and, when expressed as being “over” or “above” another component, may be meant to be “over” or “above” another component with a third component in between. In contrast, a component, such as a layer, a film, a region, or a plate, when expressed as being “underneath” another component, is meant to be vertically “underneath” another component, and, when expressed as being “under” or “below” another component, may be meant to be “under” or “below” another component with a third component in between.

Unless otherwise specified, all numbers, values, and/or expressions, used in the present specification, that specify a component, a reaction condition, an amount of polymeric composition, and an amount of mixture are approximate. This is because they reflect various uncertainties of measurement that may occur in obtaining them, when associated with substantially different objects. For this reason, in all cases, they should be understood as being modified by the term “approximately.” In addition, when a range of numerical values is used in the present specification, unless otherwise specified, these numerical values range continuously from a minimum value up to and including a maximum value. Moreover, when this range refers to an integer, unless otherwise specified, the numerical values, ranging continuously from a minimum value up to and including a maximum value, are all integers.

When a range of variables is used in the present disclosure, this range should be understood as consisting of sub-ranges, each including values ranging from a minimum value up to and including a maximum value. For example, a range of “5 to 10” not only refers to integers 5, 6, 7, 8, 9, and 10, but also consists of arbitrary sub-ranges. This range can include a sub-range from integers 6 to 10, a sub-range from integers 7 to 10, a sub-range from integers 6 to 9, and a sub-range from integers 7 to 9. Furthermore, the range of “5 to 10” consists of arbitrary sub-ranges that can include both integers and any value between valid integers within the scope of the described range, such as 5.5, 6.5, and 7.5, a sub-range of decimal numbers 5.5 to 8.5, and a sub-range of real numbers 6.5 to 9. In addition, for example, a range of “10% to 30%” not only refers to integer percentages of 10%, 11%, 12%, and so forth up to 30%, but also consists of arbitrary sub-ranges. This range can include a sub-range of integer percentages of 10% to 15%, a sub-range of integer percentages of 12% to 18%, and a sub-range of integer percentages of 20% to 30%. Furthermore, the range of “10% to 30%” consists of arbitrary sub-ranges that can include both integer percentages and decimal percentages. The range can include a sub-range of decimal percentages of 10.5%, 15.5%, and 25.5%.

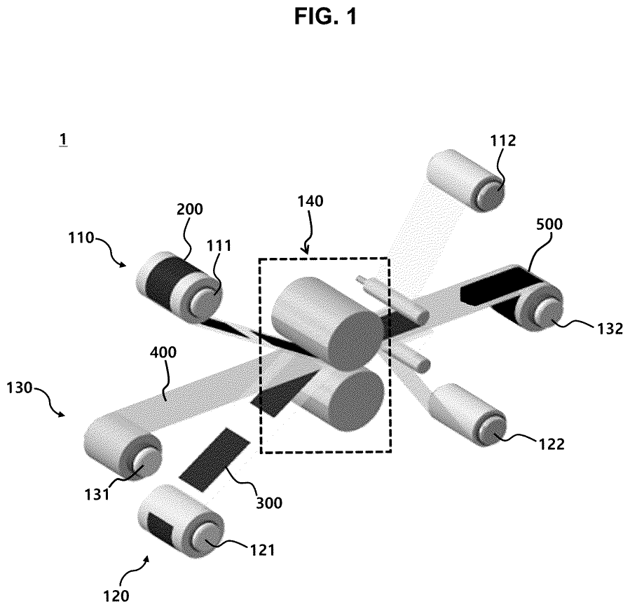

FIG. 1 is a perspective view illustrating a system 1 for manufacturing a membrane-electrode assembly according to an embodiment of the present disclosure. The system 1 for manufacturing a membrane-electrode assembly may be used to manufacture a membrane-electrode assembly (MEA) 500 using an apparatus 100 for manufacturing a membrane-electrode assembly, a first electrode film 200, a second electrode film 300, and an electrolyte membrane 400. The apparatus 100 includes a first transportation unit 110, a second transportation unit 120, a third transportation unit 130, and one pair of roll presses 140.

The first transportation unit 110 may include a first supply unit 111 and a first retraction unit 112. The first supply unit 111 may supply the first electrode film 200 to a nip gap between the roll presses 140 in one pair by unwinding the wound first electrode film 200.

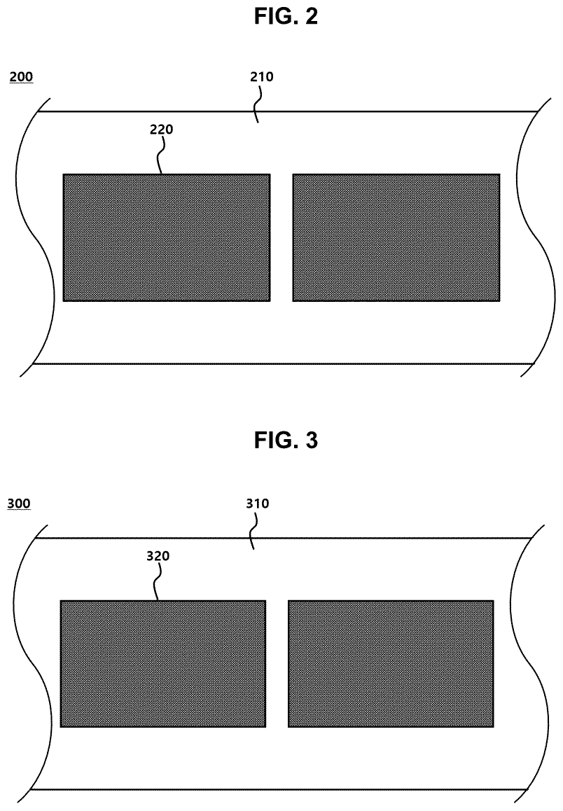

FIG. 2 is a view illustrating the first electrode film 200 that is used according to the present disclosure. The first electrode film 200 may be created by coating the first release paper sheet 210 with a first electrode material 220.

The first release paper sheet 210 may be formed of at least one selected from the group consisting of polytetrafluoroethylene (PTFE), polyethyleneterephthalate (PET), polyimide (PI), polyethylene naphthalate (PEN), silicon, and a combination thereof, but not limited thereto.

The first electrode materials 220 may contain an electrode active material slurry, which is obtained by mixing an active material, a conductive additive, a binder, and a solvent, but not limited thereto.

By winding up, the first retraction unit 112 may retract the first release paper sheet 210 from which the first electrode material 220 is transferred to one side of a primary surface of the electrolyte membrane 400.

The second transportation unit 120 may include a second supply unit 121 and a second retraction unit 122. By unwinding, the second supply unit 121 may supply the second electrode film 300 to the nip gap between the roll presses 140 in one pair.

From FIG. 3, it can be seen that, in the same manner as the first electrode film 200, the second electrode film 300 can be created by coating a second release paper sheet 310 with a second electrode material 320, but not limited thereto.

The second release paper sheet 310 may be formed of at least one selected from the group consisting of polytetrafluoroethylene (PTFE), polyethyleneterephthalate (PET), polyimide (PI), polyethylene naphthalate (PEN), silicon, and a combination thereof, but not limited thereto.

The second electrode material 320 may contain an electrode active material slurry, which is obtained by mixing an active material, a conductive additive, a binder, and a solvent.

By winding up, the second retraction unit 122 may retract the second release paper sheet 310 from which the second electrode material 320 is transferred on the other side of the primary surface of the electrolyte membrane 400.

The third transportation unit 130 may include a third supply unit 131 and a third retraction unit 132. By unwinding, the third supply unit 131 may transport the wound electrolyte membrane 400 in such a manner as to be introduced into the nip gap between the roll presses 140.

The electrolyte membrane 400 may have the shape of a sheet. The shape of a sheet refers to a three-dimensional shape that has two primary surfaces facing each other. The two primary surfaces may each be not only geometrically flat, but also partly curved. The two primary surfaces may each have a concavo-convex surface that is formed when manufacturing the electrolyte membrane 400. In this sense, the shape of a sheet is not limited to a comparatively thin cube.

The electrolyte membrane 400 that can be used according to the present disclosure may be formed of, for example, a material with a thickness of 20 μm or less and a tensile strength of 300 MPa or less, expanded polytetrafluoroethylene (ePTFE) impregnated with an ionomer, or the like. There are no specific constraints on the choice of an electrolyte-membrane material of which the electrolyte membrane 400 is formed as long as a fuel cell can be formed thereof.

The third transportation unit 130 transports the electrolyte membrane 400 in such a manner as to be interposed between the first electrode film 200 and the second electrode film 300. Accordingly, the third transportation unit 130 may be arranged between the first transportation unit 110 and the second transportation unit 120.

The third retraction unit 132 may wind the membrane-electrode assembly (MEA) 500, which is formed by attaching the first electrode material 220 and the second electrode material 320 on both primary surfaces, respectively, of the electrolyte membrane 400.

The roll presses 140 in one pair may form the membrane-electrode assembly (MEA) 500 by pressing, downward from above and upward from below, respectively, against the first electrode film 200, the electrolyte membrane 400, and the second electrode film 300 that are pulled in between the roll presses 140 from one lateral direction. The roll presses 140 in one pair may include a first roll press and a second roll press. The first roll press presses downward from above again the first electrode film 200, the electrolyte membrane 400, and the second electrode film 300. The second roll press presses upward from below against them. The first and second roll presses 140 may rotate their respective independent rotational shafts.

The roll presses 140 in one pair apply a pressure of 1 MPa to 500 MPa against the first electrode film 200, the electrolyte membrane 400, and the second electrode film 300, but not limited to this pressure. In addition, the roll presses 140 may apply a temperature of 10° C. to 300° C. to the first electrode film 200, the electrolyte membrane 400, and the second electrode film 300 while pressing against them, but not limited to this temperature range.

Through pressing and heating processes, one of the roll presses 140 may transfer the first electrode material 220 on the first electrode film 200 to a primary surface of one side of the electrolyte membrane 400 and the other one of the roll presses 140 may transfer the second electrode material 320 on the second electrode film 300 to a primary surface of the other side of the electrolyte membrane 400, thereby forming the membrane-electrode assembly 500.

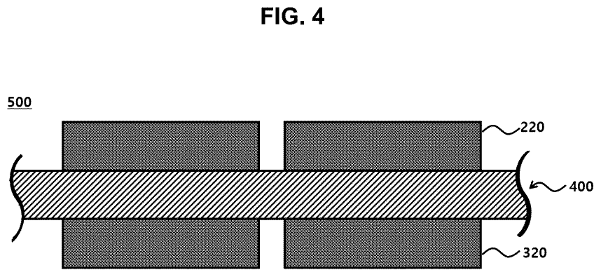

The membrane-electrode assembly 500 may be formed by stacking the first electrode material 220, the electrolyte membrane 400, and the second electrode material 320 on top of one another. A cross-sectional of the membrane-electrode assembly 500 is illustrated in FIG. 4. The membrane-electrode assembly 500 may be formed by sequentially stacking the first electrode material 220 and the second electrode material 320 on the primary surface of one side of the electrolyte membrane 400 and the primary surface of the other side thereof, respectively.

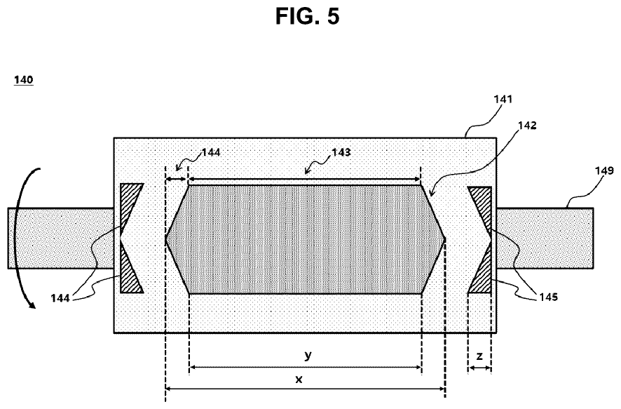

FIG. 5 is a view illustrating one of the roll presses 140 in one pair in a first implementation example according to the embodiment of the present disclosure. One of the roll presses 140 in one pair may include a primary-reaction-section pattern 142 formed in a manner that protrudes from a surface thereof, and an auxiliary-reaction-section pattern 145 formed in a manner that protrudes from the surface thereof. The primary-reaction-section pattern 142 may be arranged on a center portion of the roll press 140. The auxiliary-reaction-section patterns 145 may be arranged in a lengthwise direction of rotational shaft 149 of the roll press 140 to both sides, respectively, of the primary-reaction-section pattern 142.

At least one primary-reaction-section pattern 142 may be provided on a surface of one of the roll presses 140. In addition, correspondingly, at least one auxiliary-reaction-section pattern 145 may be provided on the surface of one of the roll presses 140. The auxiliary-reaction-section pattern 145 may be arranged to be spaced apart from the primary-reaction-section pattern 142.

The primary-reaction-section pattern 142 may have at least one of a polygonal shape and a curve shape. The primary-reaction-section pattern 142 may have a polygonal shape having n (n is an even number that is equal to or greater than 6) sides and angles. The primary-reaction-section pattern 142 in the first implementation example may have a hexagonal shape. The primary-reaction-section pattern 142 may include an embossed body 143 and protrusions 144 having a triangular shape. The protrusions 144 protrude from the embossed body 143 in the lengthwise direction of the rotational shaft 149, that is, from both ends, respectively, of the embossed body 143 in a widthwise direction of the electrolyte membrane 400.

The protrusion 144 extends from the embossed body 143 over a distance that corresponds to a predetermined width. This distance may be adjusted by considering a position at which a sub-gasket for manufacturing the membrane-electrode assembly 500 is joined. Accordingly, respective overlapping areas of a sub-gasket and an electrode can be reduced. Thus, problems can be avoided, such as an increase in unevenness during connection for a fuel cell assembling, an occurrence of bubbles, and an increase in the number of electrodes not in use. In addition, an electrode material can be applied through the protrusion 144 much more to an area where the electrode material is not applied than in a case where the primary-reaction-section pattern 142 has a rectangular shape. This can prevent the unused space from remaining idle. In addition, an edge portion of the protrusion 144 is fittingly indented unlike in the case where the primary-reaction-section pattern 142 has a rectangular shape. This can provide the advantage of improving the durability.

The auxiliary-reaction-section pattern 145 may have at least one of a polygonal shape and a curve shape. The auxiliary-reaction-section pattern 145 may correspond in shape to the protrusion 144 of the primary-reaction-section pattern 142. Accordingly, this facilitates uniform application of transfer pressure to the electrode material and the electrolyte membrane 400 to which the electrode material is attached on the same line. In a case where the protrusion 144 in the first implementation example has a triangular shape, the auxiliary-reaction-section pattern 145 may have a corresponding triangular shape that aligns with the protrusion 144. In the case where the protrusion 144 in the first implementation example has a triangular shape, four auxiliary-reaction-section pattern 145 may be formed in the shape of triangles, corresponds to one primary-reaction-section pattern 142. However, these four auxiliary-reaction-section patterns 145 are not limited to the shape of triangles.

The primary-reaction-section pattern 142 has a maximum width x in a widthwise direction of the electrolyte membrane 400. The primary-reaction-section pattern 142 has a width y (expressed as a point at which the width of the primary-reaction-section pattern 142 is minimized) in the widthwise direction of the electrolyte membrane 400 at an arbitrary point thereon. The auxiliary-reaction-section pattern 145 has a width z in the widthwise direction of the electrolyte membrane 400 on the same line as the above-mentioned arbitrary point. The widths x, y, and z can satisfy following Equation 1.

$$x = y + 2 z \qquad Equation 1$$

That is, a total sum of the width y at an arbitrary point on the primary-reaction-section pattern 142 and the width z of the auxiliary-reaction-section pattern 145 on the same line as the above-mentioned arbitrary point can be kept constant. Accordingly, the roll presses 140 may keep the transfer pressure uniformly applied to the first electrode film 200, the electrolyte membrane 400, and the second electrode film 300 downward from above and upward from below, respectively.

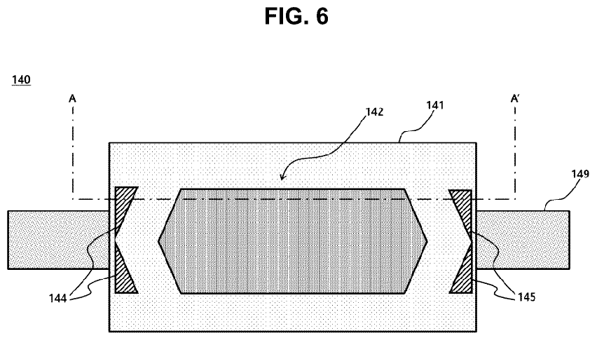

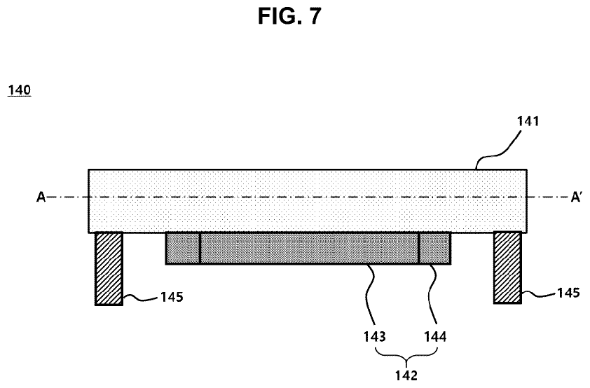

FIG. 7 is a cross-sectional view taken along line A-A′ on a surface of the roll press 140 in the first implementation example in FIG. 6.

With reference to FIG. 7, the primary-reaction-section pattern 142 and the auxiliary-reaction-section pattern 145 may be formed to have a predetermined thickness in a manner that protrudes from a surface 141 of the roll press 140. The auxiliary-reaction-section pattern 145 may have a greater thickness than the primary-reaction-section pattern 142.

In this case, the auxiliary-reaction-section pattern 145 may have a thickness smaller than the sum of respective thicknesses of the primary-reaction-section pattern 142, the first electrode film 200, the electrolyte membrane 400, and the second electrode film 300 that are pulled in from one lateral direction of the roll press 140.

For example, in a case where the thickness of the primary-reaction-section pattern 142 is 100 μm and where the sum of the respective thicknesses of the first electrode film 200, the electrolyte membrane 400, and the second electrode film 300, which are materials that are pulled in between the roll presses 140, is 55 μm, the thickness of the auxiliary-reaction-section pattern 145 may be 150 μm that is smaller than 100+55=155 μm. In this case, when the materials that are pulled in between the roll presses 140 are attached on both primary surfaces, respectively, the electrolyte membrane 400 to form the membrane-electrode assembly, the sum may decrease from 55 μm to 50 μm. The respective thicknesses of the primary-reaction-section pattern 142 and the auxiliary-reaction-section pattern 145 are not limited to the above-mentioned numerical values. They may be suitably determined by considering a total sum of the thicknesses of the material that are pulled in between the roll presses 140 and the thickness of the membrane-electrode assembly that is formed by attaching the materials on both primary surfaces, respectively, of the electrolyte membrane 400.

In order to use materials that vary widely in thickness after being attached on both primary surfaces, respectively, of the electrolyte membrane 400, the system 1 for manufacturing a membrane-electrode assembly may include an elastic body (not illustrated) arranged between the roll press 140 and the first electrode film 200 and/or between the roll press 140 and the second electrode film 300.

The elastic body may be formed of at least one selected from the group consisting of polyethyleneterephthalate (PET), polycarbonate (PC), polymethyl methacrylate (PMMA), polyethylene naphthalate (PEN), polyimide (PI), and polyethersulfone (PES), but not limited thereto.

Specifically, the elastic body may be a ductile elastic film, but not limited thereto. In addition, the elastic body may be formed of polyethylene terephthalate (PET), polyethylene naphthalate (PEN), or polyimide that is coated with rubber, silicon, or a combination thereof, but not limited thereto. The elastic body may have durability against an environment of the pressing and heating by the roll press 140, but not limited thereto.

The elastic body may have a thickness of 200 μm to 500 μm. When the elastic body has a thickness of less than 200 μm, may be not ductile enough to provide buffering between the roll press 140 and the first electrode film 200 and between the roll press and the second electrode film 300. When the elastic body has a thickness of more than 500 μm, it may interrupt heat transfer by the roll press 140.

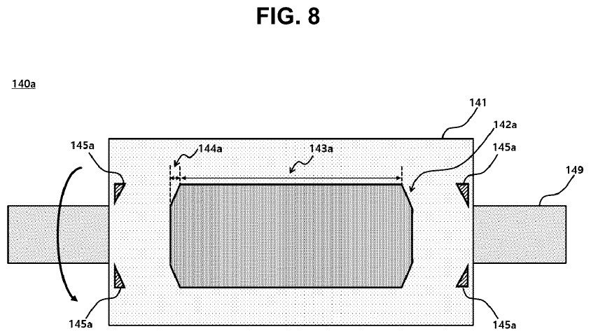

FIG. 8 is a view illustrating roll press 140a in a second implementation example according to the embodiment of the present disclosure. A primary-reaction-section pattern 142a in the second implementation example may have an octahedral shape. In a case where a protrusion 144a in the second implementation example has a trapezoidal shape, auxiliary-reaction-section patterns 145a in the shape of small triangles may be formed in such a manner that they are spaced apart from each other, corresponding to the protrusion 144a. However, these auxiliary-reaction-section pattern 145a are not limited to the shape of small triangles.

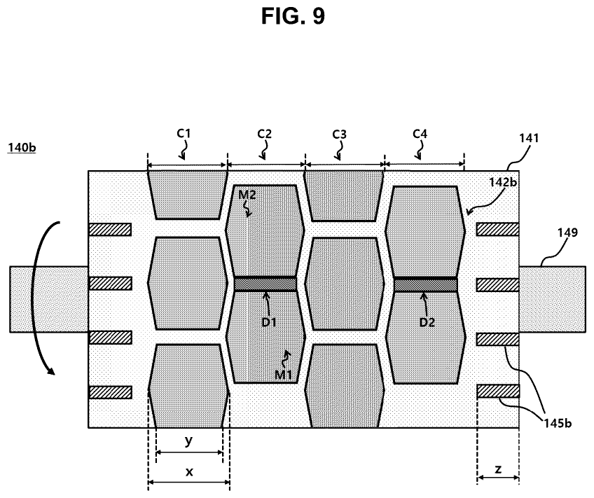

FIG. 9 is a view illustrating a roll press 140b in a third implementation example according to the embodiment of the present disclosure. In the third implementation example, primary-reaction-section patterns 142b each having a hexagonal shape may be arranged on the surface 141 of the roll press 140 in four columns in such a manner that they are spaced apart from each other. With reference to FIG. 9, four columns of the primary-reaction-section patterns 142b are referred to as the first column C1, the second column C2, the third column C3, and the fourth column C4, respectively, starting from the left side. A preceding primary-reaction-section pattern M1 in the second column C2 may be spaced a predetermined distance apart from a following primary-reaction-section pattern M2. The predetermined distance forms a first separation area D1. The primary-reaction-section pattern 142b in one of the columns C1 to C4 may be spaced the predetermined distance apart from the primary-reaction-section pattern 142b in an adjacent column, but not limited to this spacing.

In a case where the first separation area D1 is formed on the second column C2, a second separation area D2 may be formed in the fourth column C4 that is not adjacent in the lengthwise direction of the rotational shaft 149 to the second column C2. Auxiliary-reaction-section patterns 145b may be arranged on both sides, respectively, of the primary-reaction-section pattern 142b in the lengthwise direction of the rotational shaft 149 of the roll press 140, in alignment with the first separation area D1 and the second separation area D2. Similarly, the auxiliary-reaction-section patterns 145b may be arranged on both sides, respectively, the primary-reaction-section pattern 142b in the lengthwise direction of the rotational shaft 149 of the roll press 140, in alignment with the first separation area D1 between the preceding primary-reaction-section pattern M1 and the following primary-reaction-section pattern M2.

At an arbitrary point in the primary-reaction-section pattern 142b, a total sum of a length of the primary-reaction-section pattern 142b in the widthwise direction of the electrolyte membrane 400, and a length of an area where the auxiliary-reaction-section pattern 145b is formed can be expressed as a constant C in Equation 2.

$$( ( x + y ) / 2 ) * 4 = C ( C is a real number that is greater than 0 ) \qquad Equation 2$$

where x depicts a maximum width of the primary-reaction-section pattern and y depicts a width at an arbitrary point on the primary-reaction-section pattern.

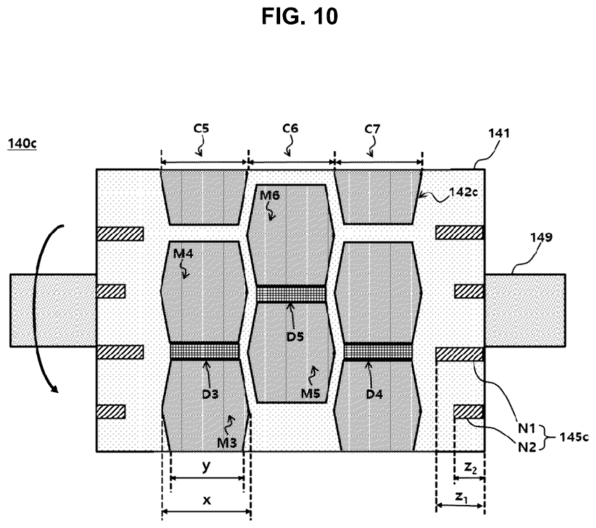

FIG. 10 is a view illustrating a roll press 140c in a fourth implementation example according to the embodiment of the present disclosure. In the fourth implementation example, primary-reaction-section patterns 142c each having a hexagonal shape may be arranged on the surface 141 of the roll press 140 in three columns in such a manner that they are spaced a predetermined distance apart. With reference to FIG. 10, three columns of the primary-reaction-section patterns 142c are referred to as the first column C5, the second column C6, and the third column C7, respectively, starting from the left side. A preceding primary-reaction-section pattern M3 in the first column C5 may be spaced a predetermined distance apart from a following primary-reaction-section pattern M4. The predetermined distance forms a third separation area D3.

When the third separation area D3 is formed in the first column C1, a fourth separation area D4 may be formed in the third column C7 that is not adjacent to the first column C1 in the lengthwise direction of the rotational shaft 149. In this case, a preceding primary-reaction-section pattern M5 in the second column C6 may be spaced a predetermined distance apart from the following primary-reaction-section pattern M6. The predetermined distance forms a fifth separation area D5. Auxiliary-reaction-section patterns 145c may be arranged on both sides, respectively, of the primary-reaction-section pattern 142c in the lengthwise direction of the rotational shaft 149 of the roll press 140, in alignment with the third separation area D3 and the fourth separation area D4.

The auxiliary-reaction-section pattern 145c in the fourth implementation example may include a long pattern N1 having a large width z1 and a short pattern N2 having a small width z2. The long pattern N1 may be arranged in alignment with] two separation areas formed on the same line [in the lengthwise direction of the rotational shaft 149 of the roll press 140. The short pattern N2 may be in alignment with one separation area formed on the same line in the lengthwise direction of the rotational shaft 149 of the roll press 140.

At an arbitrary point on the primary-reaction-section pattern 142c, a total sum of a width of an area where the primary-reaction-section pattern 142c in the widthwise direction of the electrolyte membrane 400 is formed, and a width of an area where the auxiliary-reaction-section pattern 145c is formed can be expressed a constant C in Equation 3.

$$( ( x + y ) / 2 ) * 3 = C ( C is a real number that is greater than 0 ) \qquad Equation 3$$

where x depicts a maximum width of the primary-reaction-section pattern and y depicts a width at an arbitrary point on the primary-reaction-section pattern.

That is, at an arbitrary point on the primary-reaction-section pattern 142, a total sum of a width of the primary-reaction-section pattern 142 in the lengthwise direction of the rotational shaft 149 of the roll press 140 and a width of the auxiliary-reaction-section pattern 145 on the same line in the lengthwise direction of the rotational shaft 149 of the roll press 140, at the above-mentioned arbitrary point, can be kept constant. As a result, the use of the system 1 for manufacturing a membrane-electrode assembly according to the present disclosure can apply uniform transfer pressure to the electrode material and the electrolyte membrane 400 to which the electrode material is attached on the same line. Thus, factors contributing to deterioration in fuel cell quality, such as porosity, density differences, and variations in electrode area within the membrane-electrode assembly 500 can be addressed and resolved.

Unlike in a case where an electrode material is applied in the shape of a rectangle, the use of the roll press 140, including the primary-reaction-section pattern 142 that is shape-changed according to the present disclosure, can reduce an unused area of the electrolyte membrane. Furthermore, the use of the roll press 140 can efficiently supply gas to the membrane-electrode assembly 500.

In addition, the roll press 140's including a plurality of the primary-reaction-section patterns 142 can further improve the productivity. The auxiliary-reaction-section pattern 145 can compensate for non-application of the electrode material to the separation area between the primary-reaction-section patterns 142. Thus, the transfer pressure can be kept uniformly applied to the electrode material and the electrolyte membrane to which the electrode material is attached on the same line in the lengthwise direction of the rotational shaft 149 of the roll press 140. Accordingly, quality deviation, such as porosity within an electrode can be prevented.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. A system for manufacturing a membrane-electrode assembly, the system comprising:
a first transportation unit configured to transport a first electrode film;
a second transportation unit configured to transport a second electrode film;
a third transportation unit configured to transport an electrolyte membrane having a predetermined width such that the electrolyte membrane is interposed between the first electrode film and the second electrode film; and
one pair of roll presses configured to press, downward from above and upward from below, against the first electrode film, the electrolyte membrane, and the second electrode film that are pulled in therebetween from one lateral direction;
wherein at least one of the one pair of the roll presses comprises:
a primary-reaction-section pattern protruding from a surface of the one of the pair of the roll presses; and
a first auxiliary-reaction-section pattern protruding from a first side of the primary-reaction-section pattern, and a second auxiliary-reaction-section pattern protruding from a second side of the primary-reaction-section pattern in a widthwise direction of the electrolyte membrane.

2. The system of claim 1, wherein the primary-reaction-section pattern comprises at least one of a polygonal shape and a curve shape, and
wherein the primary-reaction-section pattern comprises a plurality of primary-reaction-section patterns arranged to be spaced apart from each other.

3. The system of claim 1, wherein the primary-reaction-section pattern comprises at least one polygonal shape,
wherein the primary-reaction-section pattern comprises a plurality of primary-reaction-section patterns are arranged to be spaced apart from each other, and
wherein each of the plurality of primary-reaction-section patterns comprises:
an embossed body; and
a first protrusion protruding from a first end of the embossed body and a second protrusion protruding from a second end of the embossed body along a lengthwise direction of a rotational shaft of the roll press.

4. The system of claim 1, wherein the primary-reaction-section pattern comprises a polygonal shape having n sides and angles, where n is an even number that is equal to or greater than 6.

5. The system of claim 1, wherein the first and second auxiliary-reaction-section patterns each comprise at least one of a polygonal shape and a curved shape, and wherein the shape of each the first and second auxiliary-reaction-section patterns correspond in shape to the primary-reaction-section pattern.

6. The system of claim 1, wherein, at an arbitrary point on the primary-reaction-section pattern, a total sum of a length of the primary-reaction-section pattern in a lengthwise direction of a rotational shaft of the roll press and a length of each of the first and second auxiliary-reaction-section patterns in the lengthwise direction of the rotational shaft of the roll press on the same line as the arbitrary point is kept constant.

7. The system of claim 1, wherein each of the first and second auxiliary-reaction-section patterns has a greater thickness than the primary-reaction-section pattern.

8. The system of claim 1, wherein each of the first and second auxiliary-reaction-section patterns has a thickness smaller than the sum of respective thicknesses of the primary-reaction-section pattern and a thickness of the first electrode film, the electrolyte membrane, and the second electrode film that are pulled in between the roll presses from one lateral direction.

9. The system of claim 1, wherein each of the first and second auxiliary-reaction-section patterns has a thickness that is the same as the sum of a thickness of the primary-reaction-section pattern and respective thicknesses of the first electrode film, the electrolyte membrane, and the second electrode film that are pushed out in the other lateral direction.

10. The system of claim 1, further comprising:
an elastic body arranged at least one of a position between the roll press and the first electrode film and a position between the roll press and the second electrode film.

11. The system of claim 10, wherein the elastic body is formed of at least one selected from the group consisting of:
polyethyleneterephthalate (PET), polycarbonate (PC), polymethyl methacrylate (PMMA), polyethylene naphthalate (PEN), polyimide (PI), and polyethersulfone (PES).

12. The system of claim 10, wherein the elastic body has a thickness of 200 μm to 500 μm.

13. The system of claim 1, wherein the primary-reaction-section pattern comprises a plurality of primary-reaction-section patterns, each of the plurality of primary-reaction-section patterns comprising a hexagonal shape;
wherein the hexagonal shapes of the plurality of primary-reaction-section patterns are alternatively arranged to be spaced a predetermined distance apart from each other; and
wherein the first and second auxiliary-reaction-section patterns comprise triangular shapes that correspond to the hexagonal shapes of the plurality of primary-reaction-section patterns.

14. The system of claim 1, wherein the primary-reaction-section pattern comprises a plurality of primary-reaction-section patterns having octagonal shapes;
wherein the octagonal shapes of the plurality of primary-reaction-section patterns are alternatively arranged to be spaced a predetermined distance apart from each other;
wherein the first and second auxiliary-reaction-section patterns have triangular shapes that correspond to the shapes of the plurality of primary-reaction-section patterns; and
wherein the first and second auxiliary-reaction-section patterns having the triangular shapes are arranged to be spaced apart from each other.

15. The system of claim 1, wherein the roll press includes n columns of a plurality of primary-reaction-section patterns, where n is a natural number that is equal to or greater than 2;
wherein the plurality of primary-reaction-section patterns comprise hexagonal shapes;
wherein the hexagonal shapes of the plurality of primary-reaction-section patterns are alternatively arranged to be spaced a predetermined distance apart from each other; and
wherein the first and second auxiliary-reaction-section patterns correspond in shape to the plurality of primary-reaction-section patterns, but the sum of a width of the first and second auxiliary-reaction-section patterns in a widthwise direction of the electrolyte membrane at an arbitrary point on each of the plurality of primary-reaction-section patterns and a width of the first and second auxiliary-reaction-section patterns is kept constant.

16. The system of claim 1, wherein the roll press includes three or more columns of the plurality of primary-reaction-section patterns.
